(19) United States
(12) Patent Application Publication
(10) Pub. No.: US 2008/0261738 A1
(43) Pub. Date: Oct. 23, 2008

(54) CHAIN TRANSMISSION SYSTEM

(76) Inventor: Joseph Stout, Royal Oak, MI (US)

Correspondence Address: RICHARD M. SHARKANSKY, PO BOX 557, MASHPEE, MA, 02649, US

(21) Appl. No.: 11/736,285

(22) Filed: Apr. 17, 2007

(51) Int. Cl. F16H 55/30

(52) U.S. Cl. 474/152

(57) ABSTRACT

A chain transmission system having a drive sprocket, a driven sprocket, a chain having a front side engaging teeth on the drive sprocket and teeth on the driven sprocket, and a rotary wheel having rubber outer surface. A backside of the chain engages the rubber outer surface of the driven wheel.

### TECHNICAL FIELD

This invention relates generally to chain transmission systems and more particularly to chain transmission systems wherein one portion of elements engages a front side of a chain used is such system and another portion of elements in the system engage a backside of the chain.

### BACKGROUND

As is known in the art, chain driven systems (i.e., chain transmission systems) have many applications, such as for example, in motor vehicles. In one such application, a drive sprocket is mounted to the drive shaft of the vehicle's internal combustion engine. A chain has links engaging the teeth of the drive sprocket and teeth of a driven sprocket mounted to a camshaft of the engine. Thus, rotation of the engine drives the engine's camshaft.

In some chain transmission systems additional sprockets are driven. For example, a sprocket may be connected to the links to drive a water pump. In some applications, the water pump pulley is driven by the backside of the chain. In another application, the backside of the chain may be used to engage an idler sprocket that spins but does no work other than to direct or guide the motion of the chain. This is possible with a standard roller chain, but this type of drive creates high levels of chain mesh noise and vibration. An inverted tooth or silent chain can reduce mesh noise, but the chain becomes very wide, heavy, and is prone to stretch over time if back drive teeth are added. The guiding of the chain also becomes an issue with chain teeth on both sides. Another technique is to use a roller chain and a toothed rubberized sprocket or a metal cushion ring sprocket.

### SUMMARY

In accordance with the present invention, a chain transmission system is provided having a drive sprocket, a driven sprocket, a chain having a front side engaging teeth on the drive sprocket and teeth on the driven sprocket, and a rotary wheel having rubber outer surface. A backside of the chain engages the rubber outer surface of the driven wheel.

With such an arrangement, because the teeth are removed from the central back-drive sprocket and over-molded with rubber, the back drive can be driven through friction from the relative smooth backside of a silent chain. This back drive on the flat side is similar to how a cogged belt is used to back drive a sprocket. This enables the incorporation of a silent chain into the design which reduces chain mesh noise and eliminates all mesh frequency noise from the central, back-driven sprocket.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a sketch of a chain transmission system used in an internal combustion engine according to the invention;

FIG. 2 is a cross sectional diagram of a wheel used in the chain transmission system of FIG. 1 with a portion of a roller chain used in such system having a backside engaging a rubberized outer peripheral surface of the wheel in accordance with the invention; and

FIG. 3 is a cross sectional diagram of a wheel used in the chain transmission system of FIG. 1 with a portion of an inverted chain used in such system having a backside engaging a rubberized outer peripheral surface of the wheel in accordance with the invention.

Like reference symbols in the various drawings indicate like elements.

### DETAILED DESCRIPTION

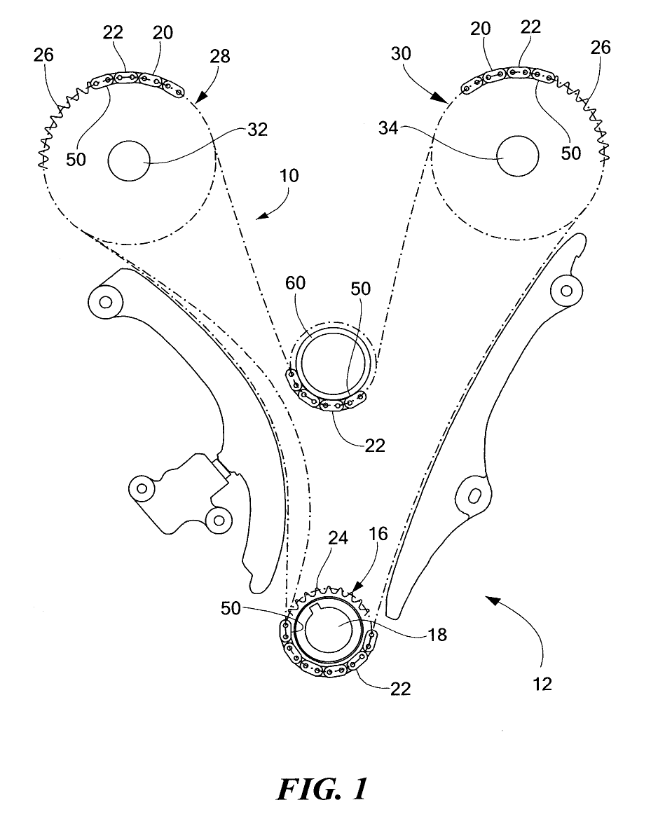

Referring now to FIG. 1, a chain driven system 10 (i.e., chain transmission system) is shown for an internal combustion engine 12. The chain transmission system 10 includes a metal drive sprocket 16 is mounted to the drive shaft 18 of the internal combustion engine 12. A chain 20 has links 22 here for example roller links, engaging the teeth 24 of the drive sprocket 16 and teeth 26 of a pair of driven metal sprockets 28, 30 mounted to a pair of camshaft 32, 34, respectively, of the engine 12. Thus, rotation of the engine drives the pair of engine camshafts 32, 34 through the chain transmission system 10.

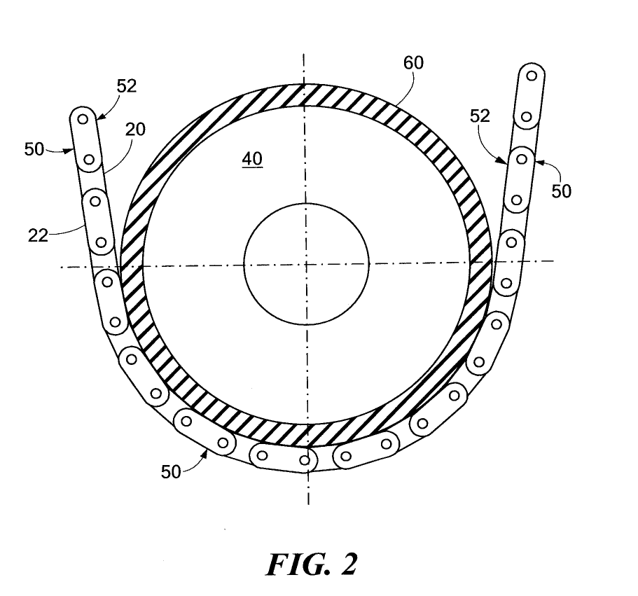

It should be noted that the teeth 24, 28, and 30 engage the front side 50 of the chain 20. The engine 12 also includes a rotary wheel 40, here connected for example to a water pump, not shown, driven by the backside 52 of the chain 20, engaging a toothless rubberized outer surface 60 of the wheel 40, as shown more clearly in FIG. 2. More particularly, the wheel 40 is here metal with rubber 60 affixed to the outer periphery of the wheel 40. Thus, the chain transmission system 10 has one portion of elements, here sprockets 16, 28 and 30 engage a front side of the chain 20 and another portion of elements, here wheel 40 in the system chain 10 have a rubberized 60 outer surface engaging the backside 52 of the chain 20.

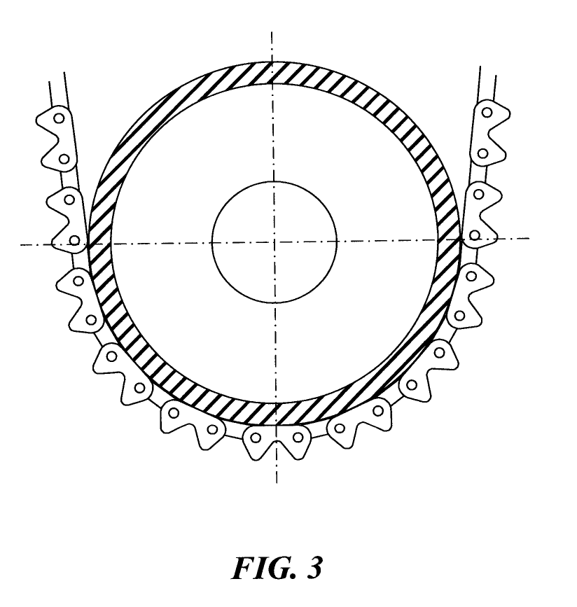

Referring now to FIG. 3, here the chain transmission system uses an inverted tooth or silent chain shown engaging the outer rubber surface of the wheel 40.

A number of embodiments of the invention have been described. Nevertheless, it will be understood that various modifications may be made without departing from the spirit and scope of the invention. Accordingly, other embodiments are within the scope of the following claims.

What is claimed is:

1. A chain transmission systems wherein one portion of elements engage a front side of a chain used is such system and another portion of elements in the system chain have a rubber outer surface engaging a back side of the chain.

2. The chain system recited in claim 1 wherein the rubber outer surface is toothless.

3. The chain system recited in claim 1 wherein the first mention portion of elements includes a drive sprocket and a driven sprocket.

4. The chain system recited in claim 3 wherein the chain has a front side engaging teeth on the drive sprocket and teeth on the driven sprocket.

5. The chain system recited in claim 4 wherein the rubber outer surface is toothless.

6. The chain system recited in claim 5 wherein the drive sprocket has metal teeth and wherein the chain has a front side engaging the metal teeth on the drive sprocket.

7. The system required in claim 6 wherein the wheel has a metal inner portion and wherein the rubber is disposed about the outer portion of the inner portion.

8. A chain transmission system, comprising:
a drive sprocket;
a driven sprocket;
a chain having a front side engaging teeth on the drive sprocket and teeth on the driven sprocket;
an rotary wheel having rubber outer surface; and
wherein a backside of the chain engages the rubber outer surface of the driven wheel.

9. The system recited in claim 8 wherein the drive sprocket is metal and wherein the chain is metal.

10. The system required in claim 8 wherein the wheel has a metal inner portion and wherein the rubber is disposed about the outer portion of the inner portion.

11. The system recited in claim 8 wherein the drive sprocket is driven by a drive shaft of an internal combustion engine and wherein the driven sprocket is attached to a camshaft of the engine.

12. The system recited in claim 10 wherein the drive sprocket is driven by a drive shaft of an internal combustion engine and wherein the driven sprocket is attached to a camshaft of the engine.

13. The chain system recited in claim 12 wherein the rubber outer surface is toothless.
